(19) United States
(12) Patent Application Publication
(10) Pub. No.: US 2016/0342632 A1
(43) Pub. Date: Nov. 24, 2016

(54) Method, Apparatus And Computer Program Product For Generating Summaries And Automated Reports Describing Changes To A Database

(71) Applicant: HERE GLOBAL B.V., VELDHOVEN (NL)

(72) Inventors: Paul Ford, Oak Park, IL (US); Prasanth Nair, Naperville, IL (US); Siraj Ahmed, Glen Ellyn, IL (US); Kenneth Kowalik, Chicago, IL (US)

(21) Appl. No.: 14/717,208

(22) Filed: May 20, 2015

(51) Int. Cl. G06F 17/30

(52) U.S. Cl. CPC G06F 17/30309; G06F 17/30554

(57) ABSTRACT

A method, computer program, and apparatus are provided for generating summaries of changes in a geographic database used by mapping, navigation, and similar applications. The summaries may be included in an automated release report. Changes such as new roads, and any other changed data in the geographic database may impact various client systems. Administrators of client systems may review the automated release reports and summaries therein to easily determine what changes have been made in a new version of the database. Depending on the client, various levels of granularity and varying data may be included in the summaries and report.

### TECHNOLOGICAL FIELD

An example embodiment of the present invention relates generally to databases, and more particularly, to a method, apparatus and computer program product for generating summaries of changes in a geographic database to include in an automated release report.

### BACKGROUND

The use of mapping and navigational applications is abundant in various technologies. Geographic databases may provide the foundation for such applications, and may include information relating to low-level data points such as node, or small units of linear measurement such as road segments.

Geographic databases comprise large amounts of information associated with the various data points, such as information relating to navigation, routing, points of interest (POIs), speed limits, and/or the like. The various applications, third party systems, and software may utilize different information from the database.

Additionally, changes to the geographic database may be made on an ongoing basis to ensure the most up to date information is reflected and provided to users, In some examples, new data such as data relating to new roads, new POIs, and/or the like may be added to geographic databases. Furthermore, changes to existing data may be continuously made as traffic patterns change due to construction, or the like.

### BRIEF SUMMARY

A method, apparatus, and computer program product are therefore provided for generating summaries of changes in a geographic database to include in an automated release report.

An apparatus for generating an automated release report describing changes to a database may include at least one processor and at least one memory including computer program code, with the at least one memory and the computer program code configured to, with the processor, cause the apparatus to at least compare a first version of a database to a second version of the database. The at least one memory and the computer program code are further configured to identify a plurality of changes that have occurred from the first version of the database to the second version, identify at least one group of the plurality of changes based on at least one commonality, aggregate the respective changes within each identified group to generate respective summaries, and generate the automated release report by incorporating a plurality of summaries.

A method is also provided for generating an automated release report describing changes to a database. The method includes comparing a first version of a database to a second version of the database and identifying, with a processor, a plurality of changes that have occurred from the first version of the database to the second version. The method further includes identifying at least one group of the plurality of changes based on at least one commonality, aggregating the respective changes within each identified group to generate respective summaries, and generating the automated release report by incorporating a plurality of summaries.

A computer program product is also provided for generating an automated release report describing changes to a database. The computer program product may include at least one non-transitory computer-readable storage medium having computer-executable program code instructions stored therein, with the computer-executable program code instructions comprising program code instructions to compare a first version of a database to a second version of the database. The computer-executable program code instructions may further include program code instructions to identify a plurality of changes that have occurred from the first version of the database to the second version, identify at least one group of the plurality of changes based on at least one commonality, aggregate the respective changes within each identified group to generate respective summaries, and generate the automated release report by incorporating a plurality of summaries.

An apparatus is also provided that comprises means for comparing a first version of a database to a second version of the database, means for identifying a plurality of changes that have occurred from the first version of the database to the second version, means for identifying at least one group of the plurality of changes based on at least one commonality, means for aggregating the respective changes within each identified group to generate respective summaries, and means for generating the automated release report by incorporating a plurality of summaries.

In some examples, the means for aggregating the respective changes comprises means for accumulating data values by linear distances associated with each of the group of the plurality of changes. In some embodiments, the at least one group is identified based on at least two commonalities. In some embodiments, the at least one commonality includes a geographic commonality such that the granularity of an associated generated summary is impacted based on the geographic commonality.

In some examples, the at least one commonality includes a functional class indicating a priority level. In some examples, the at last one group of changes is identified independently of respective record types. In some embodiments, the at least one commonality and the plurality of summaries are identified based on at least a client system for which the automated release report is being generated.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of an apparatus according to an example embodiment;

FIG. 2 is a flowchart of operations according to an example embodiment;

FIGS. 3A and 3B provide an example automated release report, according to an example embodiment; and

FIG. 4 is a flowchart of operations according to an example embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), may be differentiated from a “computer-readable transmission medium,” which refers to an electromagnetic signal.

A method, apparatus and computer program product are provided in accordance with an example embodiment of the present invention for generating summaries of changes in a geographic database to include in an automated release report. Various client systems of the geographic database may provide a variety of applications and information from the geographic database to end users. The client systems may desire information relating to what changes have been made in the geographic database so that they may accurately test, and if necessary, fix applications before their products are fully integrated with the latest version of the geographic database for release to end users.

In some examples, cartographers or geo-analysts located world-wide may study changes to roads, POIs, traffic enforcement, speed limits, construction zones and/or the like, and enter the updated or new data into the geographic database. The geo-analysts may enter manual release notes to describe the changes made to the database or individual tables, such as by manually documenting the changes in the geographic database or other centralized source used by many geo-analysts. However, the different sources of data may result in inconsistences of how the changes are captured. For example, some geo-analysts may forget to provide descriptions of their changes, enter typographical errors, or describe similar changes in a different way than another geo-analyst user. In some instances, the geo-analyst may not provide the same amount of details as another geo-analyst, such that when compiled, the manual release notes are inconsistent, confusing and/or misleading to clients.

Furthermore, some information may not be relevant to some clients, such that the provider of the geographic databases may need to manually review, group, and provide the relevant release notes to particular clients. For example, some clients may only access data relating to a specific geographic location. In some examples, some clients may use all data available to them, while some may only use very high-level or granular data, For example, astute department of transportation may desire data relating to state roads only by county (e.g., 320 miles of state maintained road in county XYZ). A provider of navigational software may require detailed information such as speed limits on every road segment (e.g., a segment between two precise locations, or nodes, such as those defined by longitude and latitude, for example) nationwide.

Therefore, example embodiments described herein provide for generating summaries of changes in a geographic database to include in an automated release report. The automated release report may vary depending on the client. For example, embodiments may generate summaries of changes associated with only a specified geographic area of interest for a particular client. Furthermore, example embodiments may rely on predetermined commonalties that are important to a particular client, such as construction zones or speed limits.

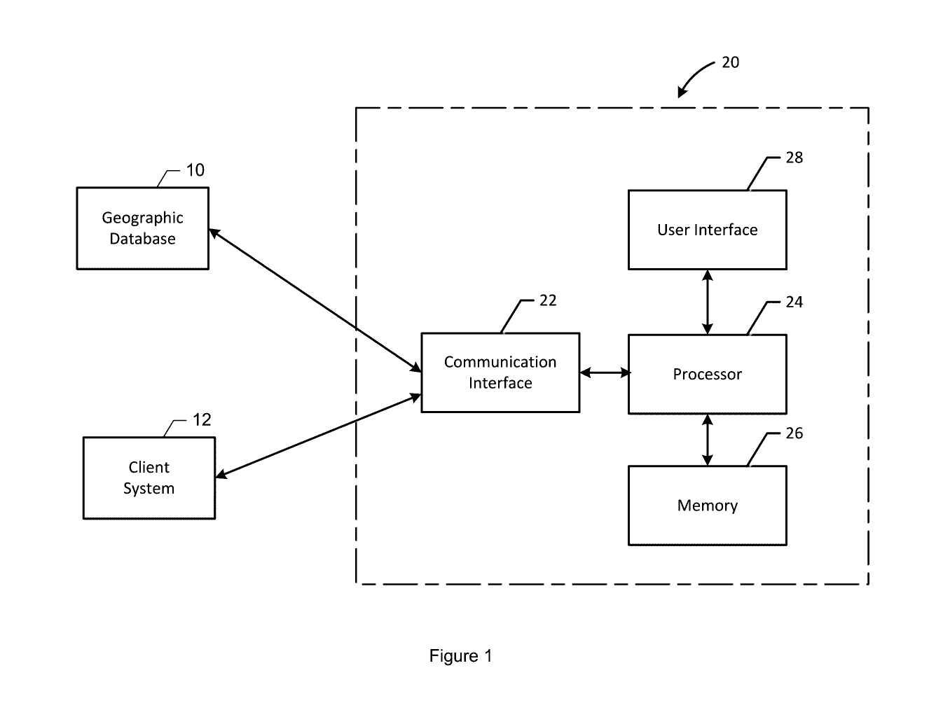

FIG. 1 is a schematic diagram of a geographic database 10 and client system 12 interacting with an example apparatus 20. Apparatus 20 is an example embodiment configured for performing any of the operations described herein, and may include communication interface 22, processor 24, memory 26, and/or user interface 28. It will be appreciated that while the geographic database 10 is used as an example throughout, it is not intended to be limiting, and example embodiments may be configured to interact with any type of database or data.

Geographic database 10 may include node data records, road segment or clip data records, link data records, point of interest (POI) data records, cartographic data records, routing data records, and/or maneuver data records. One or more portions, components, areas, layers, features, text, and/or symbols of the various types of data records can be stored in, linked to, and/or associated with the data record in the geographic database. Data records of one type may be further associated with data records of another type.

For example, one or more portions of a road segment data record may be matched with a data record defining a speed limit, a data record defining a number of lanes, a maintenance type (state or city), and/or the like. A road segment data record may be further associated with a link data record, a POI data record, an intersection data record, and/or the like.

As another example, recorded route information can be matched with respective map or geographic records via position or GPS (global positioning system) (such as using known or future map matching or geo-coding techniques), for example.

The geographic database 10 may be a server side geographic database accessible to apparatus 20 and/or client system 12 over communication interface 22, but in alternate embodiments, a client side geographic database, such as one stored on memory 26 can represent a compiled geographic database that can be used in or with a computing device to provide navigation and/or other map-related applications. For example, the geographic database can be used with the end user device, such as apparatus 20, to provide an end user with navigation features or mapping functionality, such as via user interface 28.

In some embodiments, the geographic database can be downloaded or stored on the computing device, such as in applications, or the computing device can access the geographic database through a wireless connection (such as via a server and/or a communication network), for example. Client system 112 may therefore access geographic database 10 to provide applications to end users. Client system 112 may be that of an auto manufacturer providing in-vehicle navigation, a provider of global position satellite (GPS) enabled wearable devices, geographic information system (GIS) related software, and/or the like.

Regardless of implementation, the geographic database 10 may be accessed by the apparatus 20 so that the apparatus 20 may generate summaries of changes in the geographic database to include in an automated release report, such as for client system 12, as described herein according to example embodiments.

Apparatus 20 may be embodied by or associated with any of a variety of computing devices that include or are otherwise associated with a device configured for providing the functionality described herein. For example, the computing device may be a server configured to access the geographic database 10. In some examples apparatus 20 may be implemented on the same hardware as the geographic database 10. As another example, the apparatus 20 may be implemented on a computing device within a distributed system comprising the geographic database 10 and/or client system 12 in which the apparatus, database, and/or client system communicate over a network. As yet another example, the computing device may be a personal computer or the like, configured to access the geographic database 10 and provide data and information to the client system 12.

Still further, the apparatus may be embodied by or associated with a plurality of computing devices that are in communication with or otherwise networked with one another such that the various functions performed by the apparatus may be divided between the plurality of computing devices that operate in collaboration with one another.

The apparatus 20 may include, be associated with, or may otherwise be in. communication with a communication interface 22, processor 24, a memory 26 and a user interface 28. In some embodiments, the processor (and/or co-processors or any other processing circuitry assisting or otherwise associated with the processor) may be in communication with the memory via a bus for passing information among components of the apparatus.

Memory 26 may be non-transitory and may include, for example, one or more volatile and/or non-volatile memories. In other words, for example, the memory may be an electronic storage device (for example, a computer readable storage medium) comprising gates configured to store data (for example, bits) that may be retrievable by a machine (for example, a computing device like the processor). Memory 26 may be configured to store information, data, content, applications, instructions, or the like for enabling the apparatus to carry out various functions in accordance with an example embodiment of the present invention. For example, the memory could be configured to buffer input data for processing by the processor. Additionally or alternatively, memory 26 could be configured to store instructions for execution by the processor. In embodiments in which geographic database 10 is implemented on apparatus 20, memory 26 may include the geographic database 10.

As noted above, the apparatus 20 may be embodied by a server or other similar computing device. However, in some embodiments, the apparatus may be embodied as a chip or chip set. In other words, the apparatus may comprise one or more physical packages (for example, chips) including materials, components and/or wires on a structural assembly (for example, a circuit board). The structural assembly may provide physical strength, conservation of size, and/or limitation of electrical interaction fur component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 24 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally, or alternatively, the processor may include one or more processors configured in tandem via the bus to enable independent execution of instructions, pipelining and/or multithreading.

In an example embodiment, the processor 24 may be configured to execute instructions stored in the memory device 26 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include or otherwise be in communication with a user interface 28. The user interface may include a touch screen display, a speaker, physical buttons, and/or other input/output mechanisms. In an example embodiment, the processor 24 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory device 26, and/or the like). In this regard, the apparatus 20 may access the geographic database 10 to identify changes, and summarize and report the changes to client system 12 according to example embodiments.

The apparatus 20 of an example embodiment may also optionally include a communication interface 22 that may be any means such as a device or circuitry embodied in either hardware or a combination of hardware and software that is configured to receive and/or transmit data from/to other electronic devices in communication with the apparatus. In this regard, the communication interface 22 may include, for example, an antenna (or multiple antennas) and supporting hardware and/or software for enabling communications with a wireless communication network. Additionally, or alternatively, the communication interface 22 may include the circuitry for interacting with the antenna(s) to cause transmission of signals via the antenna(s) or to handle receipt of signals received via the antenna(s). In some environments, the communication interface 22 may alternatively or also support wired communication. The apparatus 20 may access the geographic database 10 by way of communication interface 22. The apparatus 20 may additionally or alternatively communicate with a client system 12 by way of communication interface 22.

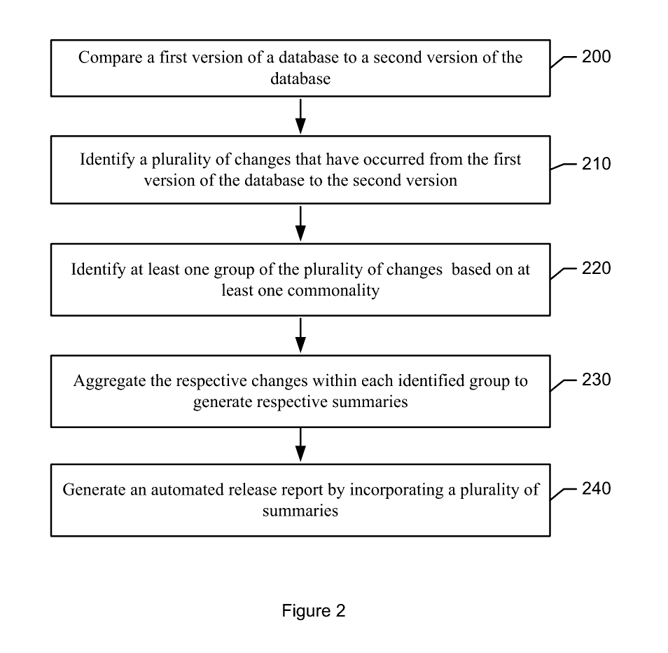

Having now described apparatus 20 according to an example embodiment, FIG. 2 is a flowchart of operations according to examples embodiments. As shown by operation 200, apparatus 20 may include means, such as processor 24, memory 26, communication interface 22, and/or the like, to compare a first version of a database, such as geographic database 10, to a second version of the database. In this regard, the geographic database 10 may comprise various historical versions, such as dated and time stamped data records tracking how values stored in the database have changed. As another example, new entries may have associated timestamps such that the apparatus 20 can determine when new data was entered. The geographic database 10 may log changes or additions to the database, such as in a separate tracking table or database, for example. In some examples, the log may be stored on memory 26.

In some examples, the apparatus 20 may generate the versions of the geographic database 10 by accessing the database and storing “snapshots” (e.g., data stored in the database at a particular moment in time) on memory 26, for example. As such, apparatus 20 may compare different versions of the database. In some examples, the first version of the database used for comparison may include the most recent version provided to a particular client, and the second version of the database may include a newer or current version of the database planned to be released to the client.

As shown by operation 210, apparatus 20 may include means, such as processor 24, memory 26, and/or the like, to identify a plurality of changes that have occurred from the first version of the database to a second version. For example, the processor 24 may compare values in the same data records from the same data tables from different versions of the database, such as geographic database 10. For example, an existing 10 miles of a road may change in speed limit, from one version of a database version to another. In some examples, new data records may be added or removed from one database to another. As another example, 15 miles of new roads may be added. Some road segments may be removed or flagged as “under construction” which may result in the road segments being removed from a table of navigable road segments. In this regard, the processor 24 may compare any version of a database that may be mirror images of each other, but captured in different points in time.

As shown by operation 220, apparatus 20 may include means, such as processor 24, memory 26, and/or the like, to identify at least one group of the plurality of changes based on at least one commonality.

Whereas the plurality of changes may include each and every data record that has changed in the geographic database 10 between two versions of the database, the groups identified in operation 220 may each include only a portion of all the changes based on the changes having commonalities. For example, the commonality may be a category or categories of the change (e.g., event type such as newly added, increased, decreased, or modified), type of the changed or newly added data record (e.g., road segment, POI, and/or the like) and/or any combination thereof.

A type of change or event type may include, for example, naming and/or address changes, navigable geometry changes, speed limit changes, and/or functional class changes.

For naming and address changes, apparatus 20 may identify any instance where any feature or record of the geographic database 10 has changed between versions. Apparatus 20 may therefore identify 15 instances of address changes, such as new homes having new addresses. As another example, apparatus 20 may identify several road name changes from the first version of the database to the second version of the database. Changes to alternate road names (e.g., I-90 Kennedy Expressway or I-90) may also be grouped accordingly.

A navigable geometry change may include changes to intersections, lane additions, directional changes of two-way to one-way or vice versa, new traffic signals, stop signs, and/or the like. An example identified group of changes may include, for example, all new traffic signals, All navigable geometry changes may be grouped together, or in some examples in smaller groups, such as traffic signal related, directional, or any of the above examples.

A functional class may include or be defined by a rating, such as level 1-5, of the priority level, importance, significance, or popularity, of a data record in the geographic database 10. Level 1 roads may include interstates, for example, while level 3 roads include city maintained roads, and level 5 roads include unmaintained gravel roads. As another example, a hospital may be considered a level 1 POI, as it is very important for users to be able to locate hospitals, whereas a concert venue may be considered a level 5 POI, as it is considered less important or less urgent to be located.

In some examples, the functional class only may be used as a commonality for grouping changes. For example, all changes to any type of data record associated with a functional class level 1, may be grouped together, such as changes to any road, POI, or the like, having a functional class of level 1. As yet another example, apparatus 20 may apply another commonality with the functional class. Therefore an identified group of changes may include changes to or newly added roads having a functional class of levels 1 and 2. Combining functional class and a type of data is an example of one combination of commonalities used to identify a group of changes, however it will be appreciated that any combination and/or number of commonalities may be used to identify a group of changes.

As yet another example, POIs may be grouped (such as a plurality of POIs located in close proximity to each other, or by a same type (e.g., public parks, museums, restaurants, automatic teller machines, etc.). Therefore changes to any POIs classified as public parks may be identified as one group of changes, for example.

Other commonalities by which apparatus 20 may group changes in the database may include an administrative level (e.g., country, state, province, region city and/or the like, region (e.g., northeast, southeast, etc.), or country (e.g., by country ISO (international Organization for Standardization) 3-code).

In some examples, changes may be grouped based on the new and old values of the changes. In this regard, the description of the change or the changed value may be considered the commonality. For example, apparatus 20 may identify three changes in which a road or road segment changed functional class from level 2 to level 3. The three changes may therefore be grouped together. Another similar example may include identifying 4 instances (e.g., road segments) of speed limit changes from 45 mph (miles per hour) to 55 mph. The four changes may then be grouped together.

The above commonalities are provided merely as example commonalities by which apparatus 20 may group changes to the geographic database 10. It will be appreciated that many other types of commonalities may be considered, as well as any combinations thereof.

Having identified groups of changes, as shown by operation 230, apparatus 20 may include means, such as processor 24, memory 26, and/or the like, to aggregate the respective changes within each identified group to generate respective summaries. In this regard, aggregating the changes may include rolling up the changes of an identified group into a summary by counting the changed records and/or accumulating values associated with the changes. In this regard, one summary of aggregated changes may be generated that encompasses and/or describes a group of changes identified with respect to operation 220.

For example, apparatus 20 may aggregate and summarize the identified changes by providing a total count of changes in the identified group. For example, “three road segments had a functional class change from level 2 to level 3”. As yet another example, the same three changes may be accumulated distance values, or linear distance values, associated with the three changes such that apparatus 20 generates a summary reciting, “27 kilometers of road had functional class change from level 2 to level 3.”

In yet another example, summaries having varying granularities of information may be generated. For example, “45 miles of roads added in Cook County,” or “350 miles of state added state-wide.” Still further, a summary based on a commonality of functional class or significance may include, “10 miles of level 1 roads added in Cook County.” In this regard, the geographic area may be considered a commonality by which the changes are grouped (in combination with added roads), and may also be referred to as a geographic commonality. In this regard, the granularity of the summary is impacted based on the geographic commonality.

As another example, data may be aggregated or grouped by contiguous stretches of road with a common name within a county: e.g. “1.7 km of I-80 in Cook County.”

Accordingly, one skilled in the art can understand that a large number of commonalities and combinations therefore can be used by apparatus 20 by which to group the changes such that a desired level of granularity, and/or significance of the changed data records is captured in the summaries.

Continuing to operation 240, apparatus 20 may comprise means, such as processor 24 and/or memory 26, to generate an automated release report by incorporating a plurality of summaries. In some examples, each generated summary may be assigned a summary identifier, or an automated release note identifier. Apparatus 20 may therefore uniquely identify each summary, and reference the summary for use in various automated release reports, for example.

In some examples, all the available generated summaries may be incorporated into one release report. As another example, a filter defining only specific geographic areas, and/or functional classes may be applied such that only a subset of summaries, such as those found to be relevant, are included in the automated release report. In some examples, a priority filter may be applied such that only the highest priority groups of changes are included in an automated release report. The respective summaries to be incorporated into a report may be identified based on the client system 12 that the report is being generated for. For example, a client profile may include details regarding what types of summaries should be included.

A client system providing a world-wide mapping functionality may therefore be provided with a report including high level summaries of changes affecting geographic areas world-wide. Since the changes cover the entire world, providing too low-level of changes may result in an overwhelming amount of data.

A client system for use by a state department of transportation in the United States on the other hand, may only be interested in interstates and other state maintained roads, and may therefore prefer lower-level summaries of the data for the specified state only.

It will be appreciated that some summaries may be incorporated into multiple automated release reports. Separate reports may be generated for respective client systems 12. As such, some summaries may be included in one automated release report, but not another.

The automated release reports may be generated and/or provided routinely such as a quarterly or monthly, or upon the release of a new version of the database. As another example, the automated release reports may be generated at different intervals based on priority. A relatively briefer but high-priority automated release report may be provided weekly, and may include level 1 functional class changes (e.g., those changes of high impact or importance, such as those relating to highly traveled interstates or high priority POIs such as hospitals). In some examples, the functional class changes may be identified independently of respective record types (e.g., roads and POI may be combined into one summary for the purpose of identifying changes to the level 1 functional class for high priority changes).

Lower priority automated release reports may be generated less frequently, such as monthly or quarterly, as it may be less important for the client system 12 to fully test and/or integrate with the low priority data records in latest version of the geographic database 10. The lower priority data records or summaries may be identified based on the functional class level, such as 4 or 5 for example.

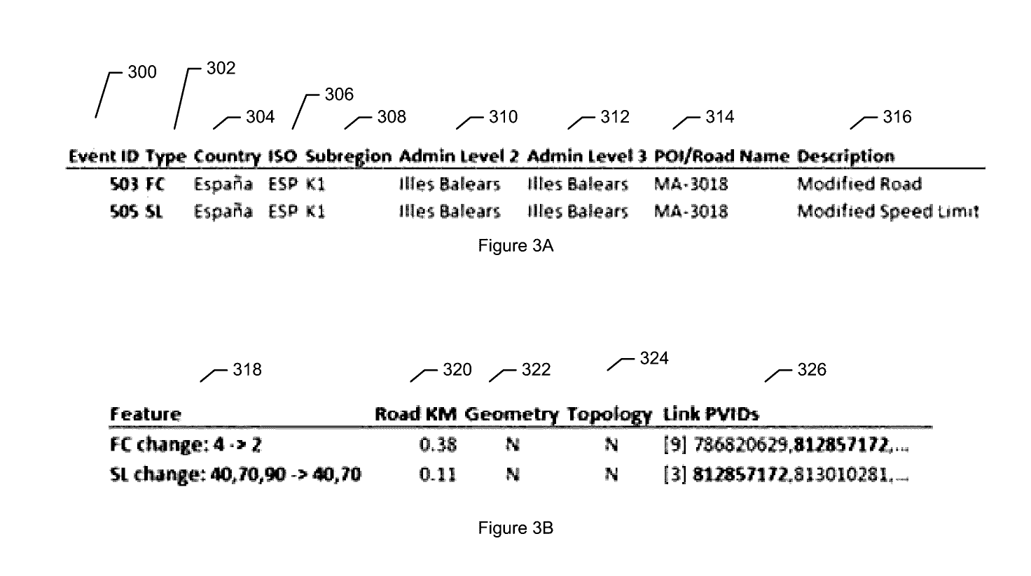

An example automated release report comprising two summaries is provided in FIGS. 3A and 3B, where FIG. 3B is a continuation of FIG. 3A. The automated release report includes, for both summaries 503 and 505, an event or summary identifier in column 300, type of data record changed 302 (e.g. functional class abbreviated FC and speed limit abbreviated SL), Country associated with the summary (304), ISO code associated with the summary (306), sub-region associated with the summary (308), admin level 2 (310), and admin level 3 (312) (the geo-analyst or other user having provided the data to the geographic database 10). Admin levels may be set 1 through 5. I may be a “country” level. The maximum level may be “settlement” or “city.” Different countries may have a different number of levels: For example, the United States may include four levels (country, state, county, city), Germany may include five where level 4 is city, and level 5 is settlement), Monaco may only include 3 levels, for example. The summaries further include a POI or road name 314, and description of changes 316, feature 318, road kilometers affected 320, geometry impacted 322 (whether routing is impacted, yes/no), topology impacted 324 (relations to other data records, yes/no), and link PVIDs (published version identifier 326, or(unique identifiers to corresponding data features such as road segments (links), POIs, cartographic features etc. The published version identifiers may therefore be published or made available to client systems. The PVIDs may therefore indicate and identify the individual data records having associated changes which are aggregated into the summary.

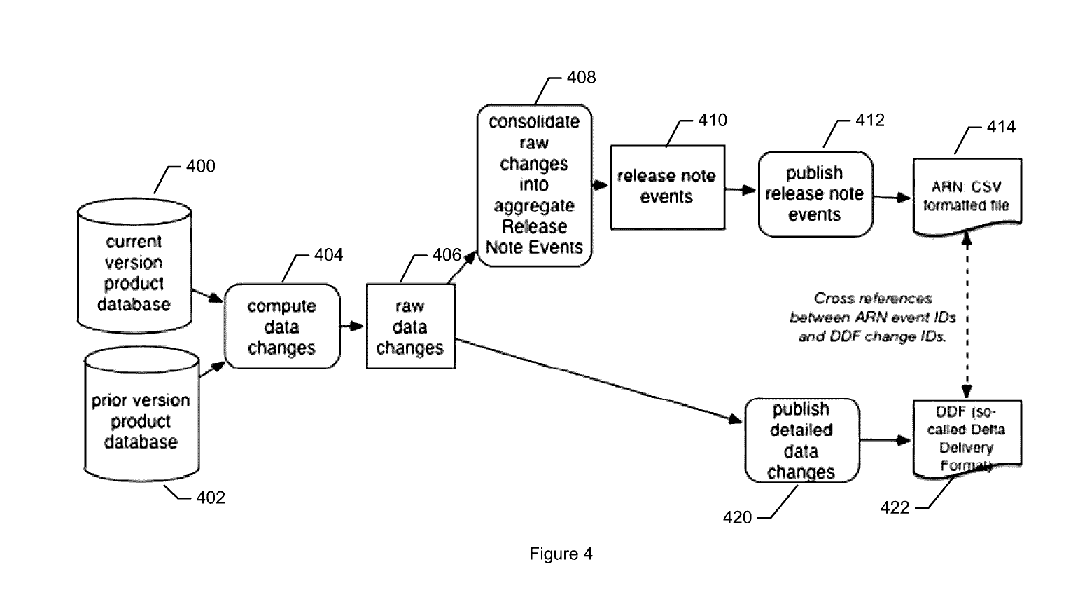

FIG. 4 is an additional flow chart according to an example embodiment. Apparatus 20 may compute data changes 404, with processor 24 and/or memory 26, between a prior version of product database 402 and current version of product database 400. As a result, the raw data changes, on a per-record basis may be identified, at 406.

Apparatus 20, with processor 24, may then consolidate the raw changes into aggregate release note events (e.g., summaries having unique summary identifiers), as shown by operation 408. Block 410 represents the release notes or summaries being stored to memory 26. As shown by operation 412, apparatus 20 may then publish the release note events or summaries to other sources, such as client system 12. The output 414 may comprise the automated release report, or ARN (automated release notes) CSV (comma separate value) formatted file, spreadsheet, and/or the like, comprising the summaries such as those provided in FIGS. 3A and 3B.

Operation 420 provides an alternative process in which each raw data change is published. The output 422 may be referred to as a delta delivery format (DDF). The DDF may be considered and any differential product used to identify or highlight changes from one version of a data record or database to another version of the same data record or database. In some examples, the summary or ARN identifier may cross reference a DDF change identifier. That is, the summary identifier and associated summary may reference multiple DDF identifiers. Similarly, a DDF identifier may reference multiple summary identifiers. In the above example of FIGS. 3A and 3B, the PVID provides the reference to the DDF.

While the DEW may be beneficial for some users, such as representatives of the client system 12, the automated release report may provide a more high-level summary for efficient interpretation and understanding of the changes provided in the most recent database version. A user may initially review automated release notes and the summaries therein, and in some examples, may access the corresponding DDF(s) to view lower level details encapsulated by the summary.

Embodiments provided herein provide for generating summaries of changes in a geographic database to include in an automated release report. Embodiments may be further configured to advantageously provide automated release notes for particular client systems 12 and/or a variety of particular client systems 12 based on the clients' needs. For example, the commonalities or combinations thereof by which apparatus 20 identifies groups of changes may be predefined in memory 26. The commonalities or combinations thereof, such as “kilometers of roads having changed speed limits” may be associated with a particular client system 12 such that when an automated release report is run for the specified client system 12, the associated commonalities are accessed in memory 26. In this regard, the release report may be automatically generated for a particular client system 12 such that the summarized changes to the database are tailored for the particular client. In this regard, apparatus 20 may efficiently manage client preferences with regard to desired data and desired level of granularity of the data, for a large number of client systems, and therefore automatically generate the client-specific release report on demand, or as a new release of the geographic database 10 is released to the client system 12.

As yet another example embodiment, a user may indicate desired commonalities via user interface 28, and apparatus 20 may generate an “on-the-fly” automated release report.

Example embodiments provided herein describe the net changes in a database in a uniform, consistent, and human readable format, and allow for generation of accurate information for marketing of the database by emphasizing the reliability and recent updates made to the database.

The relationship of data changes to summaries may be many-to-many. That is, a single data record that is changed between database versions, or newly added, may be aggregated into multiple different summaries. Similarly, each summary may include a plurality of changed data records. In some embodiments, apparatus 20 may selectively filter or ignore minor changes to data.

Example embodiments therefore provide for a multitude of combinations or groupings, forming an automated release report lattice that allows for different kinds of aggregation depending on the target client. In some examples, embodiments eliminate or limit the manual work required of geo-analysts and database engineers to track, summarize, and report changes made to the geographic database 10.

Embodiments may provide that all relevant changes are summarized completely, correctly, and consistently while eliminating or limiting human errors such as those caused by oversight, misreporting and/or inconsistent formatting. Automatic generation of the release reports and summaries therein can be provided along with advertised available products so that customers are motivated to download the products for the most up to date geographic data. Embodiments provided herein may be implemented with flexibility, such that requests for new types of summaries at varying levels of detail may be easily integrated.

Automated release reports and the summaries provided therein can be used internally by testers or users of apparatus 20, and by users of client system 12 to identify areas for focused testing and validation. While DDF or other similar comparison tools provide the finest possible level of granularity, the automated release reports provide change summaries aggregated across data record type (e.g. various combinations of commonalities) and by various methods of aggregation.

The method, apparatus and computer program product provided herein therefore provide distinct advantages to existing client systems 12. Whereas users may otherwise manually review fine grained differential reports of the database and run numerous tests of the client system, users may more efficiently identify high risk areas where many changes have been made, and test the client software accordingly. The result may include a more efficiently tested client system 12, without having to run numerous tests for each and every data record that has changed.

The method, apparatus and computer program product provided herein therefore provide distinct advantages to existing databases, such as geographic database 10. Whereas numerous database engineers and/or geo-analysts located worldwide may currently or otherwise enter manual descriptions of changes to the database putting an even higher demand on the database and utilizing additional database capacity, embodiments provided herein reduce the reliance on the database for storing the manual descriptions of the changes. Rather, embodiments provided herein automatically generate the summaries to be incorporated into release reports such that the embodiments access the database a minimal number of times to generate such summaries, which can be reused amongst various reports.

Moreover, the method, apparatus and computer program product provide numerous other technical advantages including the conservation of processing resources and the associated power consumption otherwise expended to repeatedly retrieve and/or research, on an individual data record basis, historic values and changes over time. Embodiments provided herein instead access the database to generate the summaries and automated release reports. Since the summaries may be reused, the changes to the data should only need to be accessed and identified once, or a relatively small number of times by apparatus 20, thereby conserving processing resources otherwise expended in overuse and frequent requests to the database.

As described above, FIGS. 2 and 4 illustrate flowcharts of operations of an apparatus 20, method and computer program product according to example embodiments of the invention. It will be understood that each block of the flowcharts, and combinations of blocks in the flowcharts, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, some of which have been described above. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for generating an automated release report describing changes to a database, the apparatus comprising at least one processor and at least one memory including computer program code, the at least one memory and the computer program code configured to, with the processor, cause the apparatus to at least:
compare a first version of the database to a second version of the database;
identify a plurality of changes that have occurred from the first version of the database to the second version;
identify at least one group of the plurality of changes based on at least one commonality;
aggregate the respective changes within each identified group to generate respective summaries; and
generate the automated release report by incorporating a plurality of summaries.

2. The apparatus of claim 1, wherein aggregating the respective changes comprises accumulating data values by linear distances associated with each of the plurality of changes.

3. The apparatus of claim 1, wherein the at least one group is identified based on at least two commonalities.

4. The apparatus of claim 1, wherein the at least one commonality includes a geographic commonality such that the granularity of an associated generated summary is impacted based on the geographic commonality.

5. The apparatus of claim 1, wherein the at least one commonality includes a functional class indicating a priority level.

6. The apparatus of claim 1, wherein the at last one group of changes is identified independently of respective record types.

7. The apparatus of claim 1, wherein the at least one commonality and the plurality of summaries are identified based on at least a client system for which the automated release report is being generated.

8. A method for generating an automated release report describing changes to a database, the method comprising:
comparing a first version of the database to a second version of the database;
identifying, with a processor, a plurality of changes that have occurred from the first version of the database to the second version;
identifying at least one group of the plurality of changes based on at least one commonality;
aggregating the respective changes within each identified group to generate respective summaries; and
generating the automated release report by incorporating a plurality of summaries.

9. The method of claim 8, wherein aggregating the respective changes comprises accumulating data values by linear distances associated with each of the group of the plurality of changes.

10. The method of claim 8, wherein the at least one group is identified based on at least two commonalities.

11. The method of claim 8, wherein the at least one commonality includes a geographic commonality such that the granularity of an associated generated summary is impacted based on the geographic commonality.

12. The method of claim 8, wherein the at least one commonality includes a functional class indicating a priority level.

13. The method of claim 8, wherein the at last one group of changes is identified independently of respective record types.

14. The method of claim 8, wherein the at least one commonality and the plurality of summaries are identified based on at least a client system for which the automated release report is being generated.

15. A computer program product for generating an automated release report describing changes to a database, the computer program product comprising at least one non-transitory computer-readable storage medium having computer-executable program code instructions stored therein, the computer-executable program code instructions comprising program code instructions to:
compare a first version of the database to a second version of the database;
identify a plurality of changes that have occurred from the first version of the database to the second version;
identify at least one group of the plurality of changes based on at least one commonality;
aggregate the respective changes within each identified group to generate respective summaries; and
generate the automated release report by incorporating a plurality of summaries.

16. The computer program product of claim 15, wherein aggregating the respective changes comprises accumulating data values by linear distances associated with each of the group of the plurality of changes.

17. The computer program product of claim 15, wherein the at least one group is identified based on at least two commonalities.

18. The computer program product of claim 15, wherein the at least one commonality includes a geographic commonality such that the granularity of an associated generated summary is impacted based on the geographic commonality.

19. The computer program product of claim 15, wherein the at least one commonality includes a functional class indicating a priority level.

20. The computer program product of claim 15, wherein the at last one group of changes is identified independently of respective record types.

21. (canceled)

22. (canceled)
